(19) United States
(12) Patent Application Publication
(10) Pub. No.: US 2020/0393110 A1
(43) Pub. Date: Dec. 17, 2020

(54) Reflected Light Collector System

(71) Applicant: John Frederick Rekesius, North Haledon, NJ (US)

(72) Inventor: John Frederick Rekesius, North Haledon, NJ (US)

(73) Assignee: John Frederick Rekesius, North Haledon, NJ (US)

(21) Appl. No.: 16/866,525

(22) Filed: May 4, 2020

Related U.S. Application Data
(60) Provisional application No. 62/845,310, filed on May 8, 2019.

(51) Int. Cl. F21V 13/04; F21V 7/00; F21V 5/04; F21V 7/06

(52) U.S. Cl. CPC F21V 13/04; F21V 7/0066; F21Y 2115/10; F21V 7/06; F21V 5/04

(57) ABSTRACT

The Reflected Light Collector System allows for the use of various types of lighting technologies to be used in a way that produces intense single point source light that can be controlled thru lenses like used in extremely bright projectors, concert moving head lights, theater&concert follow spots and TV/Film spot/wash lighting. Since the Reflected Light Collector System can use multiple efficient LEDs of various colors, this high intensity cumulative point light source can color mix those LEDs output when correctly controlled without the necessity of mechanically inserted color chips, color wheels or color gels like in other projected white light output fixtures thus eliminating the need for additional mechanical mechanisms in the fixture that can fail like as in ARC lamp type fixture or LED fixture with just a high intensity white light from one bulb, LED or lamp.

This system is meant to take a large number of LEDs facing a curved mirror to reflect light and concentrate light in the shortest distance possible so the total sum of all the LEDs used is condensed in a smaller more manageable beam better suited for projection thru zoom lenses, GoBos with patterns or even LCD plates to project images.

### BRIEF DESCRIPTION OF DRAWINGS AND PHOTOS

FIG. 1

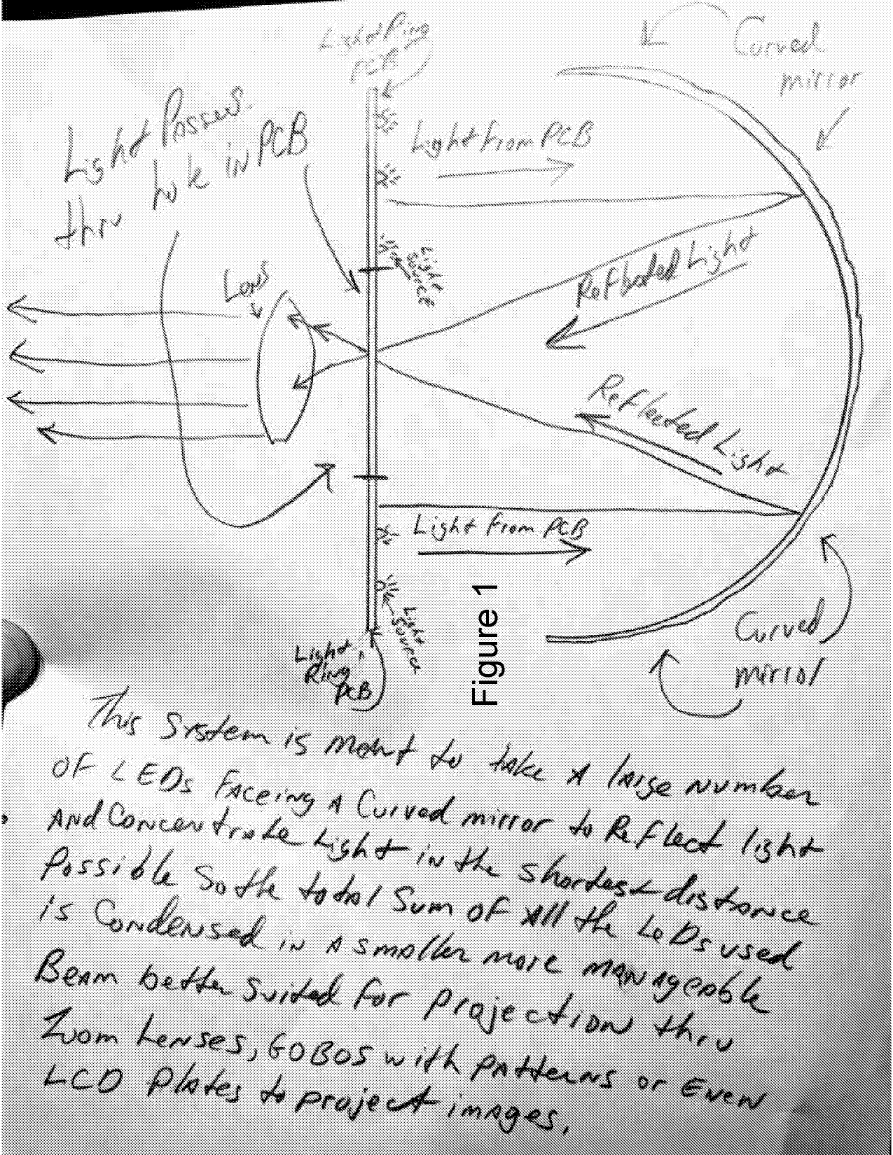

hand drawings of the led platter/panel facing a curved parabolic mirror and expected light direction of travel from light source panel to mirror and back thru hole in light source panel/platter middle. This stream of reflected light can be focused using a lens also in drawing FIG. 1.

FIG. 2

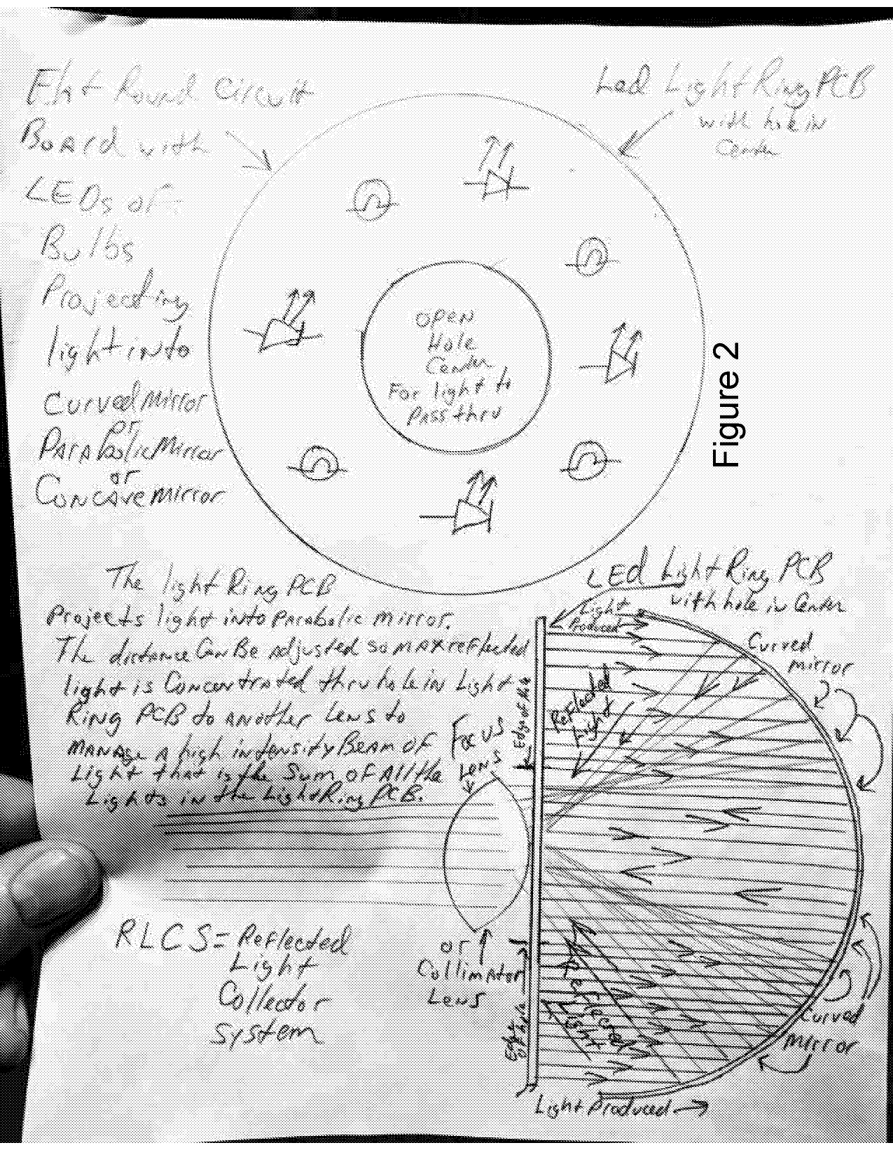

Shows a sample of some different light source and how they can be positioned around hole of light source platter/panel. FIG. 2 also shows hand drawings of the led platter/panel facing a curved parabolic mirror and expected light direction of travel from light source panel to mirror and back thru hole in light source panel/platter middle.

FIG. 3

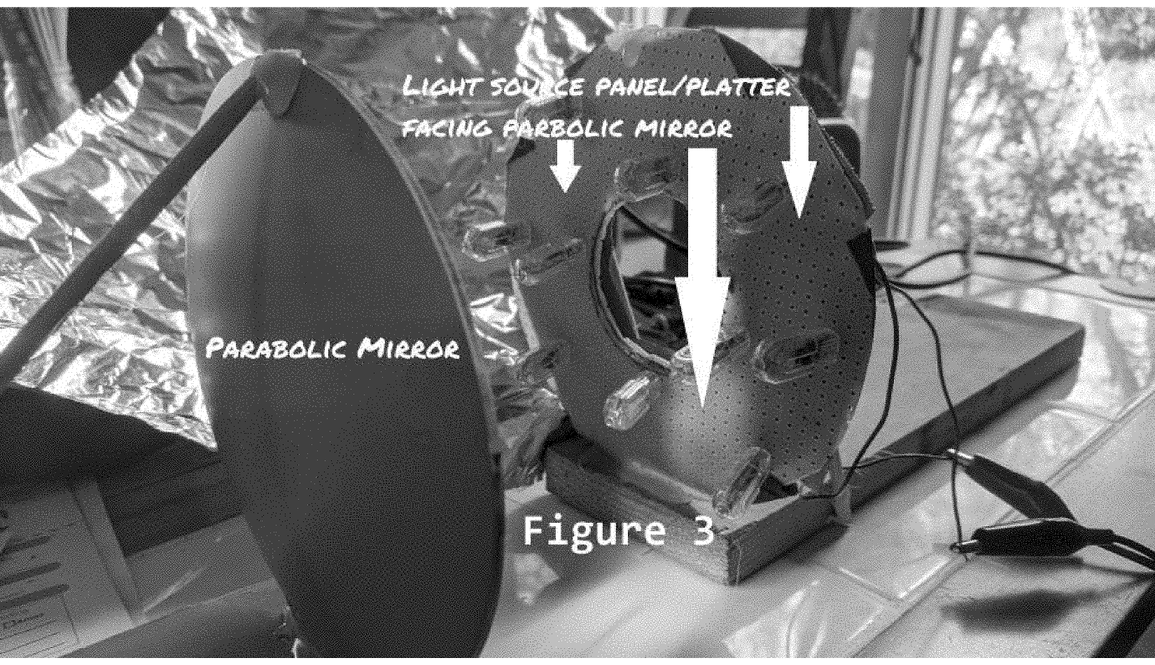

is a photo of RLCS mock up. Showing LEDs mounted on a light source platter/panel and having a hole in middle of same in which the light coining from light source platter/panel would be reflected back thru from curved mirror/parabolic mirror.

FIG. 4

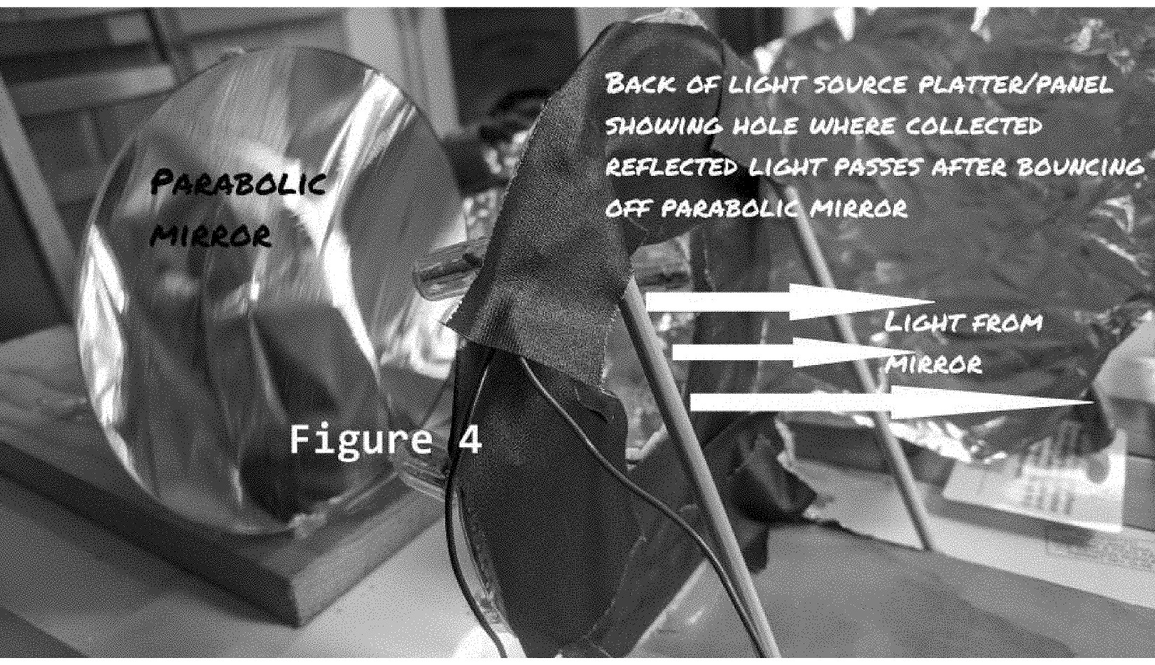

Photo depicts expected light path after having being reflected off of parabolic mirror.

FIG. 5

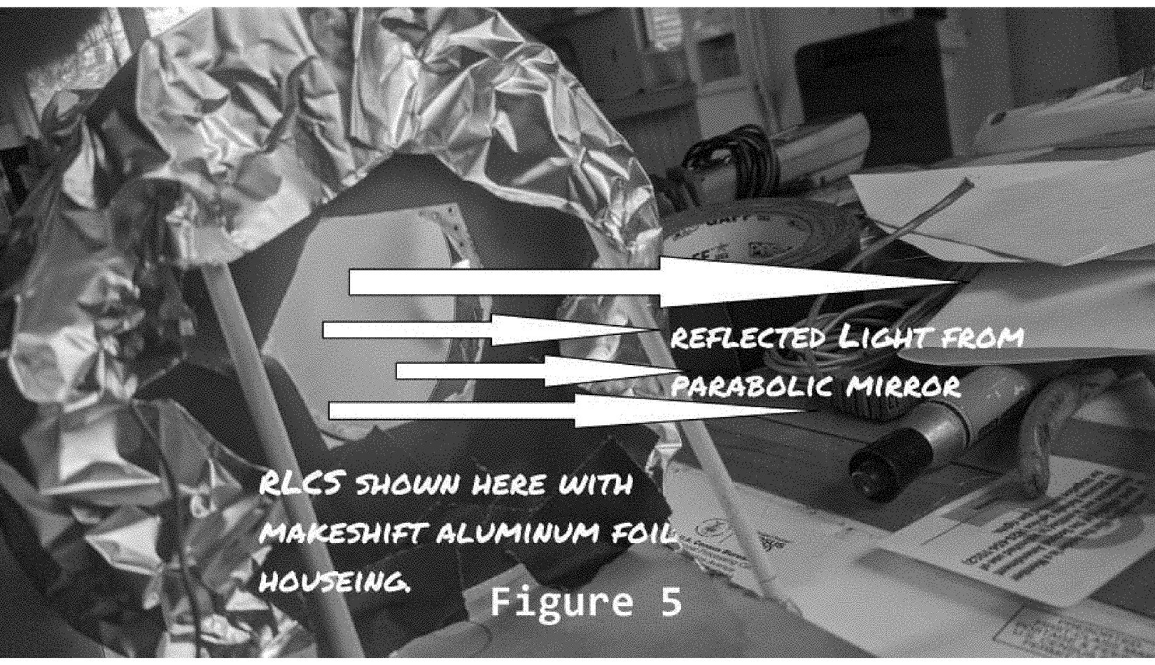

Photo depicts expected light path thru hole after having being reflected off of parabolic mirror. Also shown with makeshift aluminum housing covering the gap between the mirror and light source panel/platter.

FIG. 6

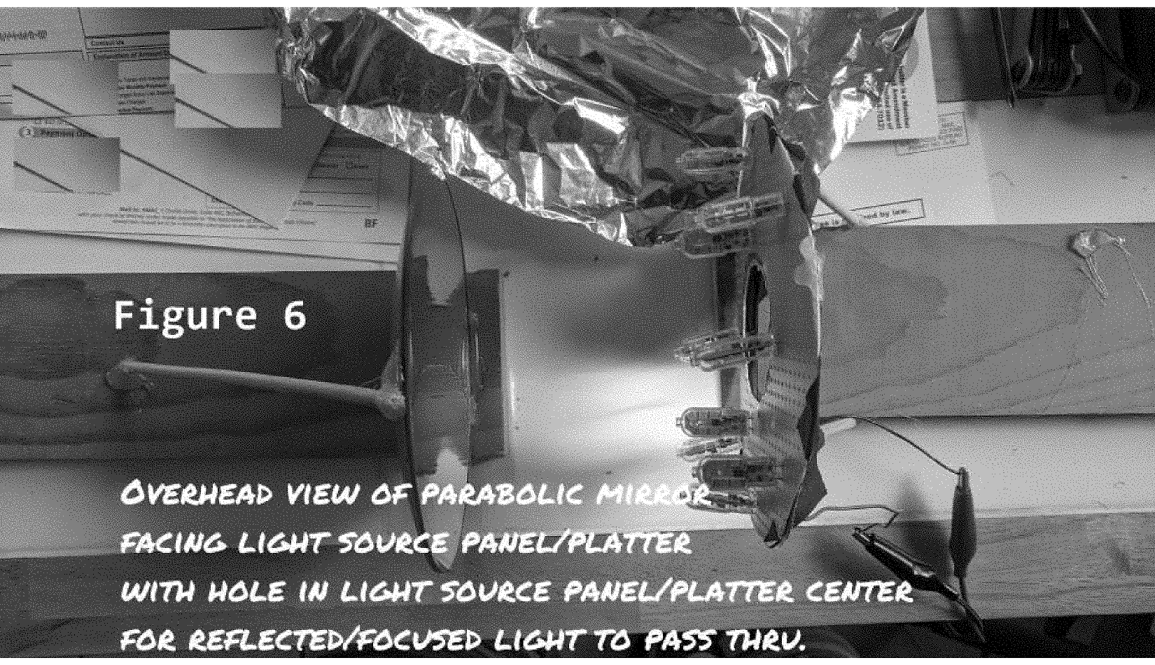

Over head view photo or RLCS without makeshift aluminum housing.

### 37 CFR 1.71 DETAILED DESCRIPTION AND SPECIFICATION OF THE INVENTION

The Reflected Light Collector System (provisional patent app No. 62/845,310) uses a curved mirror to collect “ artificial light source” that faces mirror, into a more powerful cumulative light source reflected back, this being the sum of the “artificial lights” facing mirror. By using a donut shaped flat panel with “artificial light source” mounted on it facing a curved mirror, the artificial light can be reflected back and due to the shape of the mirror, reflected focused to a smaller more intense luminance point source and back thru the hole of the donut shaped flat panel that had the “artificial light source”.

1) The idea here is to mimic super bright artificial light sources that can be controlled and projected thru various lenses like with super bright arc lamps found in professional entertainment industry stage/stadium follow spots or moving head fixtures for stage and the like. Even in projection of images in theater and advertisments in shopping malls etc. The added benefit of not using a super bright costly arc lamp configuration is that this reflected light collector system can use other means of light, the cumulative sum of less powerful lights, multiple individual light source outputs to mimic the same or better intensity output without having the necessity for an single source arc lamp ballast to power the arc lamp or single LED and the like.

2) The reflected light collector system other benefits would be, unlike single source white light arc lamp projections or high intensity single color LEDs, the reflected light collector system can be made up of multiple different color light sources if one chooses and each controlled separately for unlimited color mixing. Unlike single source white light arc lamps and LEDs that require mechanical insertion of colored glass or colored gels to do the same.

3) Reflected light collector system is future scale-able in that as lighting technology changes in performance, intensity and color, the reflected light collector system may use these new improved evolving light sources for even better, greater cumulative reflected light mixed color intense light source.

1) This reflected light system benefits the lighting industry by allowing the use of a large area of multiple low power or high power light sources on a panel roughly same size as the mirror, facing a curved mirror to be reflected from the curved mirror and concentrated/collected into one bright single, focused source back thru the center of the large light panel that had various light sources and the light beam is now the cumulative sum and brighter for use in various types of light projection that benefit from smaller/concentrated high power light sources best controlled by lenses.

2) The reflected light collector system will allow for multiple different color light sources to mix into a focused high intensity light beam thus alleviating the need for mechanically injected colored glass to achieve same like color mixed output like found in many professional theater and concert lighting extremely bright spot/wash fixtures that need colored glass/films inserted in light path to change color of the “white light” only output their arc lamps, bulbs or high output white LEDs.
